(19) United States
(12) Patent Application Publication
(10) Pub. No.: US 2010/0194097 A1
(43) Pub. Date: Aug. 5, 2010

(54) FUEL LINE AND METHOD FOR PRODUCING A FUEL LINE

(75) Inventor: Janos KERTESZ, Sulzbach (DE)

Correspondence Address: GREENBLUM & BERNSTEIN, P.L.C., 1950 ROLAND CLARKE PLACE, RESTON, VA, 20191, US

(73) Assignee: NORMA GERMANY GMBH, Maintal (DE)

(21) Appl. No.: 12/691,427

(22) Filed: Jan. 21, 2010

(30) Foreign Application Priority Data
Jan. 31, 2009 (DE) 10 2009 007 019.2

(51) Int. Cl. F16L 55/00; F16L 21/02; B23P 11/00

(52) U.S. Cl. 285/24; 277/602; 29/428

(57) ABSTRACT

A fuel line and a method for producing the fuel line. The fuel line includes a pipe having smooth walls at least at one end and a connection geometry. The connection geometry is pressed onto the at least one end.

### CROSS-REFERENCE TO RELATED APPLICATIONS

The present application claims priority under 35 U.S.C. §119(a) of German Patent Application No. 10 2009 007 019.2 filed Jan. 31, 2009, the disclosure of which is expressly incorporated by reference herein in its entirety.

### BACKGROUND OF THE INVENTION

1. Field of the Invention

The invention relates to a fuel line, in particular, a filler neck for a fuel tank, with a pipe and a connection geometry. Furthermore, the invention relates to a method for producing a fuel line of this type.

2. Discussion of Background Information

A fuel line of the type generally described above is used, e.g., to connect a fuel tank, e.g., in a vehicle, to a filler device. A part of the fuel line is generally fixedly connected to the fuel tank thereby. This part is then referred to as the filler neck. The filler neck extends in part into the fuel tank. However, it thereby also continues outside the fuel tank. As a rule, the filler neck thereby has only a small length outside the fuel tank, which is sufficient in order to have a connection geometry to which a further fuel line can be attached.

The pipe and the connection geometry are usually produced in a one-piece manner in order to ensure sufficient tightness. The production is carried out, e.g., in an injection molding process. This method necessitates relatively expensive casting molds, wherein it is difficult to carry out geometry changes.

### SUMMARY OF THE INVENTION

Embodiments of the invention reduce manufacturing costs.

According to embodiments, a fuel line of the type mentioned at the outset includes a pipe having smooth walls at least at one end and a connection geometry pressed onto the end.

The pipe itself therefore has a commercial form and can be cut to length, e.g., from a prefabricated pipe piece, and the length can easily be adapted to the installation conditions. Through the pressing of the connection geometry, a secure connection is ensured between the pipe and the connection geometry. Additional connecting elements are not necessary. The manufacturing costs are also very low, so that a cost-effective production can be achieved. Expensive casting molds are not necessary.

In particular embodiments, the pipe has a barrier layer. Fuels generally contain hydrocarbons, which diffuse through many materials. This is now prevented through the use of a barrier layer, e.g., aluminum or a plastic material, which can be embedded in the pipe.

Preferably, the connection geometry covers a front face of the pipe. Through the connection geometry, moisture, in particular fuel, is prevented from penetrating into the front face of the pipe. In the worst case, this would lead to the pipe decomposing. There is at least the risk of leakage. The safety of the connection is thus improved through the covering of the front face by the connection geometry.

Preferably, the connection geometry is embodied or formed as a double-walled sleeve with an outer wall and an inner wall. Between the outer wall and the inner wall, a receptacle region is embodied or formed to accommodate the end of the pipe is accommodated. The pipe is thus accommodated on part of its axial length inside the sleeve. A relatively large contact area is thereby formed between the sleeve and the pipe, which leads to a good seal. At the same time, a safe and reliable seat of the sleeve on the pipe is ensured. The sleeve is thereby pressed to the pipe such that the inner wall of the sleeve presses against the pipe from the inside radially outwards. It is equally possible to compress the sleeve with the pipe such that the outer wall of the sleeve presses against the pipe radially from outside inwards. This reduces the risk of fuel reaching the front face of the pipe. The sleeve can thereby be embodied or formed of steel, which leads to a good mechanical stability of the sleeve. Steel thereby has the advantage that it is easily workable and resistant to many liquids.

In embodiments, the outer wall and the inner wall bear against one another in an end region facing away from the pipe. In this manner, the mechanical stability of the sleeve is further increased. The end region, which is arranged axially outside the pipe, is thus also sufficiently stable. Because the outer wall and the inner wall bear against one another, only little construction space is necessary. The flow conditions are therefore influenced only slightly.

Preferably, a sealing element is arranged between the connection geometry and the front face. The sealing element increases the tightness between the connection geometry and the pipe. However, while pressing in the connection geometry, it also thereby prevents the front face of the pipe from being damaged by the connection geometry. Axial force peaks, which can possibly occur during the pressing, are uniformly distributed due to the sealing element. The sealing element is then arranged with a preload between the connection geometry and the front face of the pipe. The tightness is thereby increased once again.

Advantageously, the sealing element is embodied or formed as a sealing ring and arranged between the outer wall and/or the inner wall of the connection geometry and the pipe. The sealing element is then not exposed to any axial forces. Instead it is arranged in a relatively protected manner and can therefore be produced from a relatively soft material so that it can perform a good sealing function. If the sealing element is arranged between the outer wall and the pipe, the region in which environmental influences can penetrate from outside is reduced. If the sealing element is arranged between the inner wall and the pipe, the region is accordingly reduced in which a fluid can penetrate between the connection geometry and the pipe.

Preferably, the sealing element has an L-shaped cross section and covers the front face and an outer region of the pipe. The sealing element is thus embodied in a relatively large-area manner and can thus ensure a good seal. In principle, it is also possible thereby that the sealing element covers the front face and an inner region of the pipe.

Preferably, in the outer region the sealing element has a boss that extends radially outwards. This boss provides for an increase in the clamping force between the connection geometry and the pipe and thus an increase in the tightness.

In a preferred embodiment, the sealing element has a U-shaped cross section and covers the front face, the outer region and an inner region of the pipe. The end of the pipe is thus covered by the sealing element. A very good seal between the connection geometry and the pipe is achieved, and the end of the pipe is protected. The penetration of moisture into the front face of the pipe is thus virtually ruled out.

Preferably, the connection geometry has a peripheral annular groove in which a sealing ring is arranged. This sealing ring ensures a secure connection between the connection geometry and a further fuel line. Depending on whether the connection geometry is embodied as an insert part or as a receptacle element, the annular groove is thereby arranged on the radial outside or the radial inside.

Advantageously, the pipe is provided with a profiling. The profiling is thereby spaced apart from both ends of the pipe and serves to enlarge the surface in order to obtain an adequate surface for a welded joint between the pipe and a fuel tank. The profiling is formed, for example, by several annular grooves that have been sunk into the smooth walled pipe. However, these grooves must not damage the barrier layer in the pipe thereby, so they can only have a relatively small depth.

Preferably, the profiling is embodied or formed as a flange that is molded onto the pipe. A flange can be produced in virtually any desired form. The molding of the flange onto the pipe thereby ensures a durable and secure connection, wherein it is also possible to use different materials for the pipe and the flange. The position of the flange can thereby easily be adapted to the length of the pipe and thus to the installation conditions. An adjustment of the injection mold is thereby generally not necessary. Different lengths of the fuel line can thus be realized at low cost.

It is particularly preferred thereby that the flange has several peripheral grooves. The surface of the flange is thus likewise increased, in order to render possible a secure welded joint. In addition, the flange can have a radially peripheral shoulder, which serves the secure attachment to the fuel tank and thus improves the connection.

In further embodiments, the flange has an annular groove, and a radially inner side wall is formed by the pipe. This annular groove is opened in the axial direction and serves, e.g., to accommodate a connection element of the fuel tank. The fact that the radially inner side wall of the groove is formed by the pipe ensures that a large contact surface is available between the fuel tank and the pipe. The connection element of the fuel tank can then be welded to the pipe as well as to the flange. This leads to a very reliable connection.

Embodiments of the invention are directed to a method for producing a fuel line having a pipe cut to length from a smooth-walled, prefabricated pipe piece and a connection geometry pressed to an end of the pipe.

By cutting the pipe to length from a prefabricated pipe piece, the length of the fuel line can be adapted to the installation conditions at very low cost. Smooth walled pipes are very cost-effective in production thereby and are available as bulk commodities. The pipe piece and thus the pipe can already have a barrier layer in order to prevent hydrocarbons diffusing through. The pressing of the connection geometry thereby represents a simple and cost-effective connection, which at the same time ensures an adequate tightness. No additional connection elements are needed thereby, so that the costs are kept low.

It is particularly preferred thereby that the pipe is provided with a profiling. The profiling is therefore inserted into the pipe cut to length from a prefabricated pipe piece with smooth walls. The location of the profiling, that is, the distances from the respective ends of the pipe, can be established individually thereby. The adjustment to different installation conditions and profiles is therefore easily possible.

It is particularly preferred thereby that the profiling is embodied as a flange that is molded onto the pipe. Due to the molding, the embodiment of the flange is possible in virtually unlimited forms. It is thus possible, e.g., to provide the flange with peripheral grooves and/or with a radially peripheral shoulder. The flange can also be provided with an annular groove. Other embodiments of the flange are also conceivable however.

Embodiments of the invention are directed to a fuel line. The fuel line includes a pipe having smooth walls at least at one end and a connection geometry. The connection geometry is pressed onto the at least one end.

According to aspects of the embodiments, the fuel line can be a filler neck for a fuel tank.

In accordance with further aspects, the pipe can include a barrier layer.

According to embodiments of the invention, the connection geometry may be structured to cover a front face of the pipe.

According to further embodiments, the connection geometry can include double-walled sleeve having an outer wall, an inner wall, and a receptacle region formed between the outer wall and the inner wall to receive the at least one end. The connection geometry may include an end region facing away from the pipe, and the outer wall and the inner wall can be arranged to bear against one another in the end region.

In accordance with other aspects of the embodiments, a sealing ring can be arranged between the pipe and at least one of the outer wall and the inner wall of the connection geometry.

According to further embodiments, a sealing element can be arranged between the connection geometry and a front face of the at least one pipe. The sealing element can include an L-shaped cross section arranged to cover the front face and an outer region of the pipe. Further, in the outer region the sealing element can include a boss extending radially outwards. Still further, the sealing element may include a U-shaped cross section arranged to cover the front face, an outer region of the pipe, and an inner region of the pipe.

In accordance with further aspects, the connection geometry can have a peripheral annular groove in which a sealing ring is arranged.

Moreover, a profiling can be provided on the pipe. The profiling may include a flange molded onto the pipe. Further, the flange can include several peripheral grooves. The flange can also include an annular groove with a radially inner side wall formed by the pipe.

Embodiments of the invention are directed to a method for producing the above described fuel. The method includes cutting a length of pipe from a smooth-walled, prefabricated pipe piece, and pressing the connection geometry onto an end of the pipe.

In accordance with still yet other embodiments of the invention, the method can include providing a profiling on the pipe. Further, the profiling may include a flange is molded onto the pipe.

Embodiments of the invention are directed to a method for producing a fuel line. The method includes positioning a pipe section having smooth walls at least at one end to receive a connection geometry having at least inner and outer walls structured to receive the at least one end, and pressing a connection geometry onto the at least one end.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a fuel line in accordance with a first embodiment;

FIG. 2 illustrates a fuel line in accordance with a second embodiment,

FIG. 3 illustrates a fuel line in accordance with a third embodiment;

FIG. 4 illustrates a fuel line in accordance with a further embodiment;

FIG. 5 illustrates a section of the embodiment depicted in FIG. 1 with a preferred embodiment of the sealing element;

FIG. 6 diagrammatically illustrates a pipe with an L-shaped sealing element; and

FIG. 7 diagrammatically illustrates a pipe with a U-shaped sealing element.

### DETAILED DESCRIPTION OF THE EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

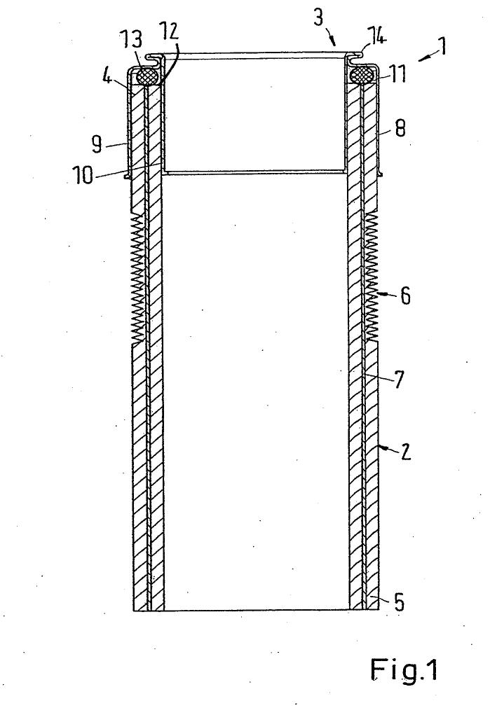

FIG. 1 shows a fuel line 1 that is embodied or formed as a filler neck for a fuel tank. The fuel tank is not shown. Fuel line 1 has a pipe 2 and a connection geometry 3. Connection geometry 3 is arranged at an end 4 of pipe 2 and connected to pipe 2 via a compression connection. A further end 5 of pipe 2 is to extend into the fuel tank.

Pipe 2 is produced from a smooth-walled, prefabricated pipe piece. Pipe 2 can be smooth-walled in the region of its ends 4 and 5, and can be provided with a profiling 6 spaced from ends 4 and 5. In this exemplary embodiment, profiling 6 is embodied or formed as peripheral grooves. These can have been, e.g., pressed into pipe 2 or inserted or formed by machining.

Pipe 2 furthermore has a barrier layer 7, which serves as a barrier to hydrocarbons and has aluminum or a corresponding plastic, for example. Pipe 2 can likewise be produced from plastic.

Connection geometry 3 is embodied or formed as a double-walled sleeve 8 with an outer wall 9 and an inner wall 10. Sleeve 8 is produced from, e.g., steel. A receptacle region 11 is located between outer wall 9 and inner wall 10, in which receptacle region end 4 of pipe 2 is accommodated. An outer diameter of inner wall 10 is thereby somewhat larger than an inner diameter of pipe 2, so that the sleeve is pressed into pipe 2 in a non-positive manner. Inner wall 10 thereby presses radially outwards against pipe 2. A very tight connection is thus produced between inner wall 10 and pipe 2.

A front face 12 of pipe 2 on end 4 is thereby covered by connection geometry 3. In addition, a sealing element 13 is arranged between connection geometry 3 and front face 12, which sealing element is embodied or formed as a sealing ring. The penetration of moisture into front face 12 is thereby reliably prevented. In addition, the tightness between connection geometry 3 and pipe 2 is increased.

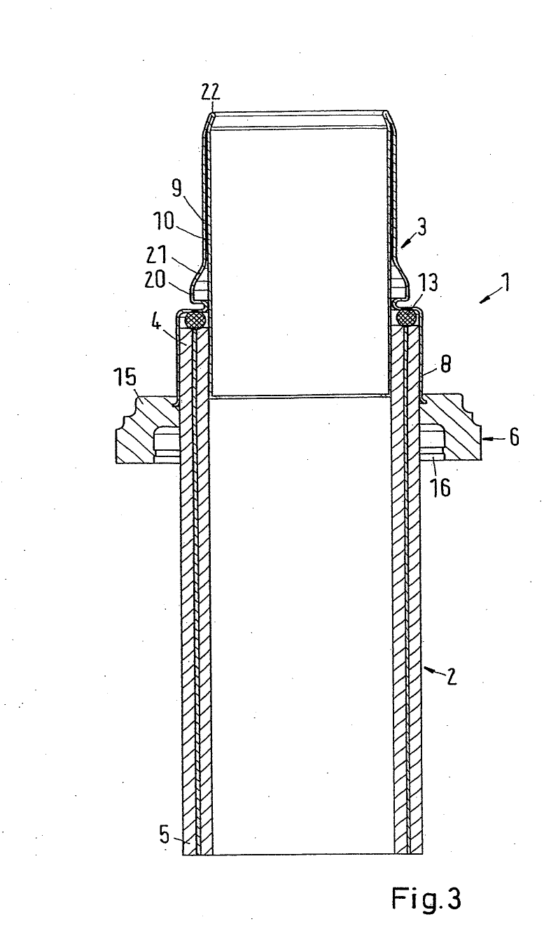

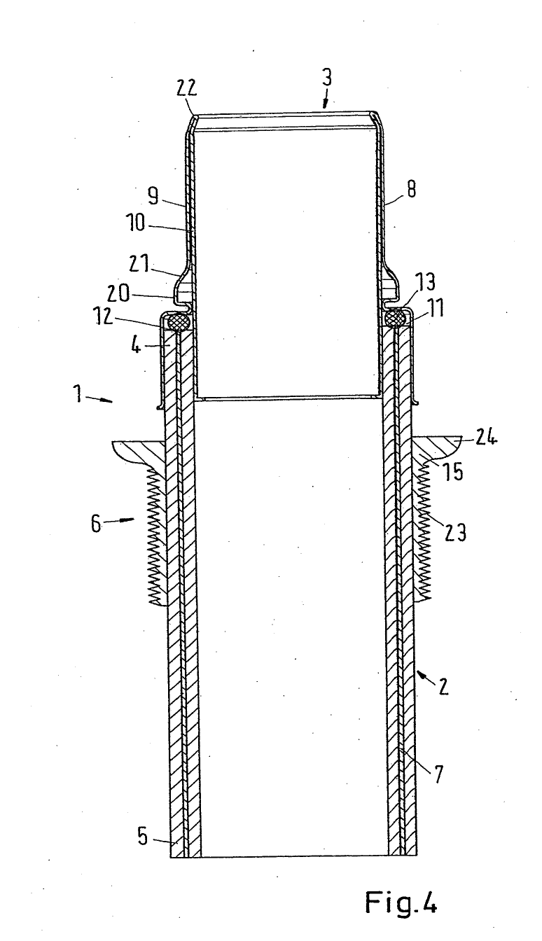

In this exemplary embodiment connection geometry 3 or sleeve 8 is embodied or formed as a receptacle element. An insert element embodied or formed in a corresponding or complementary manner, as illustrated in, e.g., FIGS. 3 and 4, can be inserted into the receptacle element. Connection geometry 3 thereby has a peripheral collar 14, which serves to accommodate a locking ring (not shown). The locking ring ensures that the receptacle element and the insert element are no longer easily detached from one another.

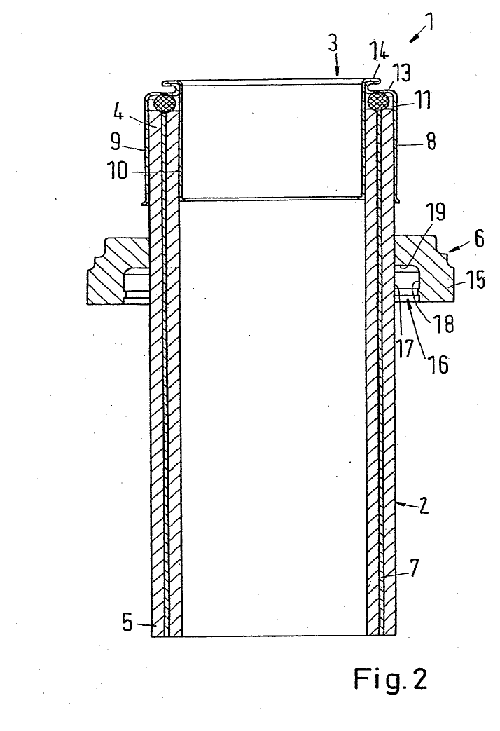

FIG. 2 shows a further embodiment of the fuel line 1, which differs from the embodiment in FIG. 1 in that the profiling 6 is embodied or formed as a flange 15, which can be molded or formed onto pipe 2. The axial position of flange 15, i.e., its spacing from ends 4 and 5, can thereby be adjusted to virtually any desired position. The adjustment of fuel line 1 to the installation conditions is therefore easily possible.

Flange 15 has an annular groove 16 that has an inner side wall 17, an outer side wall 18 and a base 19. In the illustrated embodiment, inner side wall 17 is formed by pipe 2. Annular groove 16 serves to accommodate a connection element of a fuel tank. By way of example, a welding of connection element to pipe 2 as well as to flange 15 is possible.

FIG. 3 shows a fuel line 1, with which connection geometry 3 is embodied, not as a receptacle element as in the embodiments of FIGS. 1 and 2, but as an insert element. In this embodiment, it is particularly advantageous that outer wall 9 and inner wall 10 bear against one another in an end region that faces away from pipe 2. Connection geometry 3 furthermore has a collar 20 and a chamfered edge 21. Chamfered edge 21 is designed to facilitate a locking between a locking ring and collar 20. The connection geometry 3 tapers somewhat on a front face 22 facing away from pipe 2.

This facilitates the insertion into a receptacle element. At the same time, a slight increase in rigidity results.

In this exemplary embodiment, flange 15 is not only molded around pipe 2 but also around a small region of connection geometry 3. In this manner, flange 15 additionally secures connection geometry 3 on pipe 2. Moreover, the tightness of the connection between connection geometry 3 and pipe 2 is further increased.

FIG. 4 shows a fuel line 1, which essentially corresponds to the embodiment according to FIG. 3. Profiling 6 is embodied or formed as a flange 15 having several peripheral grooves 23, which lead to an increase in surface of flange 15. In this manner, the security of a welded joint between flange 15 and a fuel tank can be increased thereby. Flange 15 furthermore has a radially peripheral shoulder 24, which in the assembly of fuel line 1 in a fuel tank can come to bear against a connection element of the fuel tank. The axial position of fuel line 1 is thereby established with respect to the fuel tank. At the same time, the security of the connection between fuel line 1 and the fuel tank is increased.

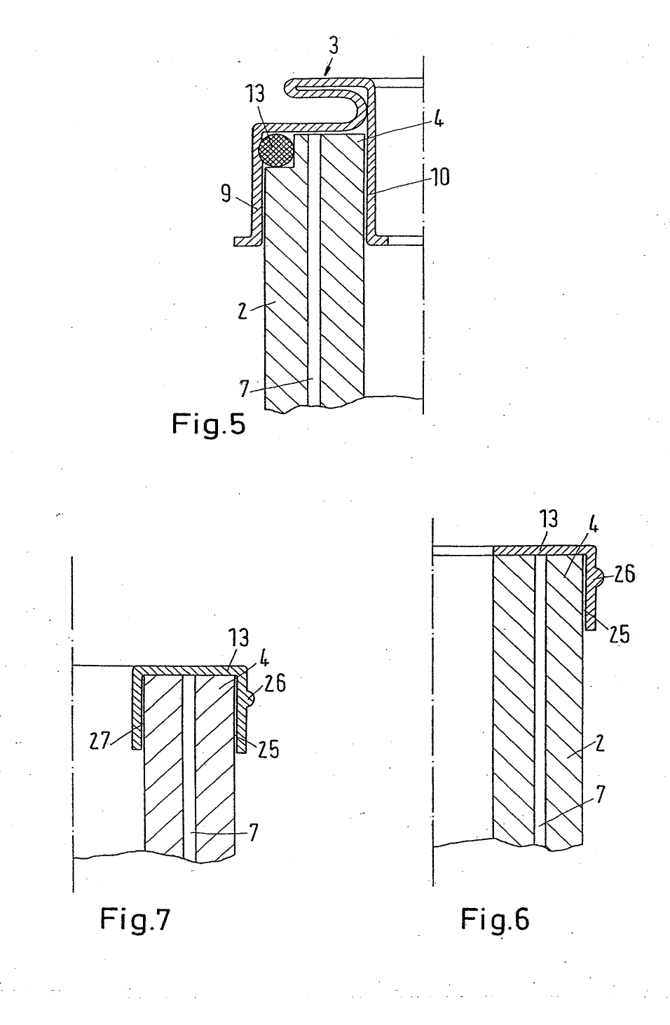

FIG. 5 shows a section from fuel line 1 according to FIG. 1, in which sealing element 13 is embodied or formed as a sealing ring arranged between outer wall 9 of connection geometry 3 and pipe 2. Further embodiments of sealing element 13 are shown in FIGS. 6 and 7, wherein for the sake of simplicity, illustration of connection geometry 3 around sealing element 13 has been omitted.

In FIG. 6, sealing element 13 has an L-shaped cross section that is arranged to cover front face 12 and an outer region 25 of pipe 2. Outer region 25 is thereby arranged at axial end 4 of pipe 2. Sealing element 13 has a boss 26 arranged to extend radially outward where it covers outer region 25 in order to increase tightness.

According to FIG. 7, sealing element 13 is embodied or formed with a U-shaped cross section to cover outer region 25, front face 12, and an inner region 27 of pipe 2. Pipe 2 is thus surrounded at its axial end 4 by sealing element 13 and thus well protected against outside influences. At the same time, sealing element 13 ensures a good seal between pipe 2 and connection geometry 3, which is not illustrated in FIG. 7. Sealing element 13 is also provided with a boss 26 that extends radially outwards. However, boss 26 is not necessary in every case.

Other embodiments of flange 15 are likewise conceivable without departing from the spirit and scope of the embodiments of the invention. However, it is advantageous that flange 15 be molded or formed onto a pipe that is cut to length from a prefabricated pipe piece. A reliable and tight connection between the flange and the pipe is thus ensured. It is possible thereby to use a commercially available pipe. Thus, a production of the entire fuel line as an injection molded part, as hitherto usual, can be avoided. Thus, production costs can be reduced. At the same time, through the connection techniques used, the press fit between the connection geometry and the pipe and the molding of the flange on the pipe, a reliable and tight connection is ensured. The fuel line according to the invention thus renders possible a cost-effective production with low expenditure. An easy adaptation to different installation conditions is possible at the same time.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A fuel line comprising:
a pipe having smooth walls at least at one end; and
a connection geometry,
wherein the connection geometry is pressed onto the at least one end.

2. The fuel line in accordance with claim 1, wherein the fuel line is a filler neck for a fuel tank.

3. The fuel line in accordance with claim 1, wherein the pipe comprises a barrier layer.

4. The fuel line in accordance with claim 1, wherein the connection geometry is structured to cover a front face of the pipe.

5. The fuel line in accordance with claim 1, wherein the connection geometry comprises a double-walled sleeve having an outer wall, an inner wall, and a receptacle region formed between the outer wall and the inner wall to receive the at least one end.

6. The fuel line in accordance with claim 4, wherein the connection geometry includes an end region facing away from the pipe, and the outer wall and the inner wall are arranged to bear against one another in the end region.

7. The fuel line in accordance with claim 1, further comprising a sealing ring arranged between the pipe and at least one of the outer wall and the inner wall of the connection geometry.

8. The fuel line in accordance with claim 1, further comprising a sealing element arranged between the connection geometry and a front face of the at least one pipe.

9. The fuel line in accordance with claim 8, wherein the sealing element comprises an L-shaped cross section arranged to cover the front face and an outer region of the pipe.

10. The fuel line in accordance with claim 9, wherein in the outer region the sealing element comprises a boss extending radially outwards.

11. The fuel line in accordance with claim 8, wherein the sealing element comprises a U-shaped cross section arranged to cover the front face, an outer region of the pipe, and an inner region of the pipe.

12. The fuel line in accordance with claim 1, wherein the connection geometry has a peripheral annular groove in which a sealing ring is arranged.

13. The fuel line in accordance with claim 1, further comprising a profiling provided on the pipe.

14. The fuel line in accordance with claim 13, wherein the profiling comprises a flange molded onto the pipe.

15. The fuel line in accordance with claim 14, wherein the flange includes several peripheral grooves.

16. The fuel line in accordance with claim 14, wherein the flange comprises an annular groove with a radially inner side wall formed by the pipe.

17. A method for producing the fuel line in accordance with claim 1, comprising:
cutting a length of pipe from a smooth-walled, prefabricated pipe piece; and
pressing the connection geometry onto an end of the pipe.

18. The method in accordance with claim 17, further comprising providing a profiling on the pipe.

19. The method in accordance with claim 18, wherein the profiling comprises a flange is molded onto the pipe.

20. A method for producing a fuel line, comprising:
positioning a pipe section having smooth walls at least at one end to receive a connection geometry, the connection geometry having at least inner and outer walls structured to receive the at least one end; and
pressing a connection geometry onto the at least one end.
